(19) United States
(12) Patent Application Publication
(10) Pub. No.: US 2019/0122649 A1
(43) Pub. Date: Apr. 25, 2019

(54) BROADBAND ACOUSTIC ABSORPTION METAMATERIALS

(71) Applicant: ACOUSTIC METAMATERIALS GROUP LIMITED, Wong Chuk Hang, Hong Kong (CN)

(72) Inventors: Ping SHENG, Kowloon, Hong Kong (CN); Shuyu CHEN, Wong Chuk Hang, Hong Kong (CN); Min YANG, Wong Chuk Hang, Hong Kong (CN)

(21) Appl. No.: 16/096,459

(22) PCT Filed: Apr. 25, 2016
(86) PCT No.: PCT/IB2016/000598

§ 371 Date: Oct. 25, 2018

(51) Int. Cl. G10K 11/168; G10K 11/172

(52) U.S. Cl. CPC G10K 11/168; G10K 11/172

(57) ABSTRACT

A sound suppression structure is made up of plural planar vibrational units, which establish plural resonant frequencies. A dissipative layer is positioned on a front side of the vibrational units with a separation between the dissipative layer and the planar vibrational units sufficient to permit substantially free movement of the planar vibrational units. A shallow sealed gas cell array is positioned behind vibrational units, with one or more of the planar vibration units forming one side of each sealed gas cell in the array. The sealed gas cell array interacts with the planar vibrational units to absorb energy at the resonant frequencies. The dissipative layer enhances absorption efficiency, resulting in absorption of energy at frequencies other than the resonant frequencies, and the combination of the planar vibrational unit, the shallow sealed gas cells and the dissipative layer providing a plurality of resonant modes for broadband sound absorption.

### BACKGROUND

### Field

The present disclosure relates to an acoustic energy absorption structure which exhibits high-efficiency acoustic energy absorption over a broadband frequency range, including those in the lower audio frequency ranges.

### Background

Absorption of low-frequency sound has been a difficult task because the dynamics of dissipative systems are generally governed by the rules of linear response. That means the dissipative power is quadratic in rates, thereby accounting for the inherently weak absorption of low-frequency sound waves by homogeneous materials. The absorption at low frequencies can be enhanced by increasing the energy density inside the dissipative materials through resonances. That technique only works for frequency ranges in the vicinities of the resonance frequencies. The absorption rate drops quickly away from the resonant frequencies, leaving broadband absorption in the low frequency regime still a significant challenge.

### SUMMARY

Sound suppression is achieved by providing a structure having plural planar vibrational units which establish plural resonant frequencies. A dissipative layer is positioned on a front side of the planar vibrational units, with the relative positioning of the dissipative layer and the planar vibrational units is sufficient to permit movement of the planar vibrational units sufficient for excitation of the planar vibrational units at the resonance frequencies. A gas cell array interacting with the planar vibrational units is used to absorb energy at the resonant frequencies. The gas cell array comprises one or more of the planar vibration units forming one side of each gas cell in the gas cell array. The dissipative layer enhances absorption efficiency, resulting in absorption of energy at frequencies other than the resonant frequencies, the combination of the planar vibrational unit. The gas cells interact with the planar vibrational unit and the dissipative layer to provide a plurality of resonant modes for broadband sound absorption.

### BRIEF DESCRIPTION OF THE DRAWINGS

FIGS. 1A-C are schematic representations of a decorated membrane used in a sound suppression panel constructed in accordance with the present disclosure. FIG. 1A is a schematic representation of a top view of the decorated membrane. FIG. 1B is a detailed view of the decorated membrane of FIG. 1A, showing the area designated as B-B in FIG. 1A, and showing a schematic representation of geometries of the rigid platelets decorated on the membrane. FIG. 1C is a schematic representation of a side view of a segment of the broadband acoustic absorption metamaterial of FIG. 1A.

FIGS. 2A and B are a depiction of absorption characteristics and a measurement setup used to generate the depiction. FIG. 2A is a graphic depiction of absorption characteristics of the broadband acoustic absorption metamaterial. FIG. 2B is a schematic representation of the measurement setup used to obtain the graphic depiction of FIG. 2A.

### DETAILED DESCRIPTION

Overview

The term “metamaterial” denotes a class of structured composites whose wave functionalities arise as the collective manifestations of its locally resonant constituent units. Recently, total absorption of low frequency sound waves, at a single frequency, was realized in a metamaterial unit whose dimensions are orders of magnitude smaller than the relevant wavelength. The mechanism comprises hybridizing two low frequency resonances of a decorated membrane, through coupling via a sealed thin gas layer behind the decorated membrane. Due to interference, waves reflected from the membrane and the hard wall of the sealed gas cell can completely cancel each other. With no reflection, total absorption would result; however, such total absorption only occurs within a very narrow frequency band around the resonance. At other frequencies, the metamaterial acts as a reflective surface.

Acoustic metamaterials are inherently narrow frequency band in character, owing to its reliance on resonances to achieve their novel properties. In this disclosure, we show that by synergistically combining the traditional acoustic dissipative materials and acoustic metamaterials, one can realize true broadband acoustic absorption. In particular, the structure in which an acoustic dissipative layer, such as acoustic sponge, is placed in front of a hybrid resonant unit (where “front” is defined to be the direction facing the incident acoustic wave, or the noise source), comprising a decorated membrane with single or multiple weights, sealing a shallow air cavity behind it. Such an arrangement is shown to imply a finite acoustic wave amplitude on the backside of the traditional dissipative layer, in contrast to a hard boundary where the acoustic wave amplitude has to vanish. As a result, the absorption capability of the traditional acoustic dissipative material layer is greatly enhanced at low frequencies, while maintaining its excellent absorption performance at high frequencies. Since such a finite acoustic wave amplitude at the hybrid resonant unit can be maintained for frequencies that are either coincident with, or inbetween the resonance frequencies of the hybrid resonant unit, a synergy is thus created that directly leads to true broadband absorption in which the absorption at the hybrid resonance frequencies is either maintained or slightly further enhanced, and at frequencies in-between the resonance frequencies the absorption is greatly increased, so that the net result is a relatively smooth, broadband absorption spectrum.

This disclosure relates to a broadband acoustic absorption metamaterial comprising a planar vibrational unit that comprises a dissipative layer, a single or multiple decorated platelets on an elastic membrane, and a shallow sealed gas cell immediately behind the decorated membrane. In addition, to elastic membranes, it is possible to use non-elastic membranes that flex in response to vibrational energy. The membranes can be provided as metal sheets, plastic sheets, composite materials (e.g., metal and plastic), laminated materials, and fabrics. Non-limiting examples of metal sheets include steel, stainless steel, copper, aluminum, and similar materials and alloys. Non-limiting examples of fabrics include cloth, papers and similar sheets or web material.

It is also possible to provide high efficiency energy absorption in a structure that comprises the membrane or sheet without decoration. It is also possible to provide high efficiency energy absorption in a structure that has a homogeneous area density distribution. One example of such a structure would provide plurality of resonant modes achieved by multiple, segmented non-decorated uniform membranes placed in an array.

Vibrational motion of the vibrational unit can have a plurality of resonant modes that are distributed in a tunable broadband frequency range. Alternatively, the plurality of resonant modes can also be achieved by multiple, segmented single-platelet planar vibrational units, placed in an array. The planar vibrational unit can also have normal displacement components that are not coupled to propagating acoustic waves and hence are evanescent in nature. The dissipative layer is placed in front of the vibrational unit (front being the direction of the incident sound wave, or the noise source) to broaden and enhance the absorption profile. This placement allows the dissipative layer to further smooth and enhance the absorption profile, as well as broaden the frequency range of acoustic energy absorption.

The sound suppression structure uses the vibrational units and the dissipative layer to provide a broadband absorption effect. The sound suppression structure is made up of plural planar vibrational units, which establish plural resonant frequencies. The dissipative layer is positioned on a front side of the planar vibrational units and is configured so that the resonance modes can be still excited in the planar vibrational units. This can be accomplished with a separation between the dissipative layer and the planar vibrational units sufficient to permit substantially free movement of the planar vibrational units with respect to the dissipative layer. Alternatively, the broadband absorption effect still maintains if the dissipative layer, while still allowing the vibrational units to respond in the plural resonant frequencies. A non-limiting example of a dissipative layer, is acoustic foam, which is positioned to touch the planar vibrational units (distance=0).

The shallow gas cell array is configured so that one or more of the planar vibration units form one side of each sealed gas cell in the sealed gas cell array. The gas cell array may be a sealed gas cell array, or the gas cells may be vented. In one non-limiting example, the gas cells have small vent holes <1 mm diameter; however, it is possible to more fully vent the gas cells to an extent that the venting of the gas cells significantly affects their sound absorption qualities. The gas cell array interacts with the planar vibrational units to absorb energy at the resonant frequencies. The dissipative layer enhances absorption efficiency, resulting in absorption of energy at frequencies other than the resonant frequencies. The combination of the planar vibrational unit, the shallow sealed gas cells interacting with the planar vibrational unit and the dissipative layer provide plural resonant modes for broadband sound absorption.

The sound suppression structure can be configured so that plural resonant frequencies can also be established by the gas cell array, through the resonance of air inside each cell, without the presence of the planar vibrational units. The plurality of resonant modes can be achieved by multiple, segmented gas cells, placed in an array, while still maintaining the broadband absorption effect.

Alternatively, plural resonant frequencies can also be established by a gas cell array, through the resonance of air inside each cell, without the presence of the planar vibrational units. That is, the plurality of resonant modes can be achieved by multiple segmented gas cells, placed in an array. This can be accomplished with plural segments behind each planar vibrational unit or with plural segments behind groups of planar vibrational units. It has been found that, when multiple segmented gas cells are used in the array, the plurality of resonant modes the broadband absorption effect is maintained.

In addition to the use of segmented gas cells, it is also possible to achieve the effects of the gas cells when the gas cell is vented. By way of non-limiting example, it is possible to maintain the effect of the gas cells with a small hole, e.g., <1 mm, on the back wall of each cell. If the hole is sufficiently small, the response to sound or vibration is substantially the same as when the cell is sealed. This configuration provides vented construction, in which the vented construction limits airflow sufficiently to allow the gas cells to respond to the energy at the resonant frequencies in the manner of sealed gas cells. It is, however, also possible to allow a larger degree of ventilation, to the extent that the ventilation will substantially affect the resonant response of the gas cells. Even with the larger degree of ventilation, the gas cells are effective.

The gas cells may also be provided with dissipative materials. Such dissipative materials can be a particular gas mixture, or can comprise other fluids or materials. The other fluids or materials can be liquids, solid particles, spongy materials or gelled materials. In one non-limiting example, dissipative materials are put into some or all of the air cells to introduce additional dissipation for sound waves. For the purpose of this disclosure, it is intended that cells containing such other fluids or materials fall within the scope of “gas cells”.

Similarly, it is possible to provide the gas cells with dissipative materials as a liner. That allows the gas cells to function as described, with the dissipative materials further absorbing vibrational energy.

One implementation of the broadband acoustic absorption metamaterial unit comprises at least one shallow cell, i.e., an indented shallow cavity, sealed by an elastic membrane. The membrane is decorated by multiple rigid platelets, which form a planar vibrational unit, with the dissipative layer placed in front. A non-limiting example of the dissipative layer comprise is a spongy material which absorbs vibrational energy. By “spongy”, it is intended to describe a material which is porous or contains entrained air or other gas, so that vibrational energy of the acoustic waves causes portions of the material to compress or decompress the gas or to otherwise flex. The multiple rigid platelets that have the same shape but different area mass densities are attached on the membrane with a predetermined distribution. Such a composite structure exhibits a high density of resonances that are clustered in frequency groups, spread over a wide frequency range. By placing a dissipative layer of absorption material in front of the vibrational unit, the absorption efficiency at frequencies between the resonances can be considerably enhanced, but without degrading the absorption at the resonance frequencies.

Technique

A strategy to achieve broadband hybrid resonance absorption is implemented by creating a large number of resonances in a given frequency range. The disclosed techniques provide high-efficiency acoustic energy absorption over a broadband frequency range, and can be used to provide acoustic energy absorption in the lower audio frequency ranges and below. By way of non-limiting example, sound absorption is targeted toward audio frequencies in the 100 to 1000 Hz range. It is understood that other frequency ranges may be targeted, including those below 100 Hz and sub-audible frequencies, as well as frequencies greater than 1000 Hz.

To achieve the energy absorption, multiple semicircular platelets are arranged on the membrane with an inhomogeneous area density distribution. In a non-limiting example, the membrane has a pre-tension in the range of 3.45 to 3.5×10⁵ Pa. This design also purposely breaks both mirror and translational symmetries of the decorated membrane, thereby removing the degeneracy of the membrane to symmetric eigenmodes, with the effect of broadening the frequency distribution of the resonances. The tension can vary significantly, with non-limiting example ranges being from 10² to 1×10¹² Pa, from 1×10² to 1×10⁸ Pa and from 1×10⁴ to 1×10⁷ Pa being broader examples.

In an open system; i.e., a system in direct contact with ambient air, radiative coupling to resonances reduces dissipation. A feature of the hybrid membrane resonator is that only its surface-averaged normal displacement, [symbol] W [symbol] , radiatively couples to the acoustic wave in air. Here W denotes the displacement normal to the membrane and [symbol] [symbol] represents surface averaging. The remaining deformation component δW≡W− [symbol] W [symbol] can only couple to evanescent waves in air, and is therefore non-radiative. Note that acoustic wavelength λ considered herein is much larger than the lateral dimensions of the membrane. It follows that |k_{∥}|>2π/λ for the k_{∥} components of δW.

The displacement continuity and the wave equation lead to:

|k_{∥}|²+k_{⊥}²=(2π/λ)² equation (1)

for waves in air, where k_{⊥} denotes the wave vector component normal to the membrane. The δW component therefore only couples to the evanescent waves because the associated k_{⊥} must be purely imaginary, since in order to maintain the validity of the wave equation requirement |k_{∥}|²+k_{⊥}²=(2π/λ)², k_{⊥}² must be negative, as |k_{∥}|>2π/λ as previously stated. In contrast, the distribution of the k_{∥} components for [symbol] W [symbol] peaks at k_{∥}=0, implying coupling to the radiative modes.

The responses of the resonator under external pressure p are described by its Green function G. For the surface averaged component, we have [symbol] W [symbol] = [symbol] G [symbol] [symbol] p [symbol] . Based on the eigenstates, i.e., the hybrid resonant modes Wₙ^{(h)} of the composite resonator, the relevant Green function can be expressed as:

$$〈 G 〉 = {\sum }_{n} \frac{{\vert 〈 {W}_{n}^{( h )} 〉 \vert}^{2}}{{ρ}_{n} ( {ω}_{n}^{2} - {ω}^{2} - 2 i ω {β}_{n} )} , \qquad equation ( 2 )$$

where ρₙ≡∫_{Ω}ρ|Wₙ^{(h)}|² dV is a parameter related to the displacement-weighted mass density for the resonator's nth eigenmode at angular eigenfrequency ωₙ, ρ is the local density, dV denotes volume differential, and Ω denotes the volume of decorated membrane.

The dissipation coefficient βₙ in equation (2) is defined by:

βₙ≡∫_{Ω}η|∇(δWₙ^{(h)}|²dV/(2ρₙ), equation (3)

where η denotes the viscosity of the membrane.

It is also convenient to use surface impedance Z≡ [symbol] p [symbol] / [symbol] \dot{W} [symbol] to characterize the resonator's reflections and transmissions (the over-dot represents time derivative). It follows that Z=i/(ω [symbol] G [symbol] ) for harmonic motions with angular frequency ω, i.e., Z and G are inversely related.

Consider a composite resonator with its membrane at z=0. An incident plane wave propagates along +z direction. With k₀ being acoustic wave vector in air, the incoming wave and outgoing wave are denoted as p=exp(ik₀z), and [symbol] p [symbol] =R exp(−ik₀z), respectively. Here R is the reflection coefficient. The resonator's surface displacement component [symbol] W [symbol] is proportional to the applied pressure via the surface-averaged Green function [symbol] G [symbol] , i.e., [symbol] W [symbol] = [symbol] G [symbol] (1+R). From Newton's law, the amplitude of air compression (and expansion) between the two surfaces is related to pressure by:

[symbol]

W [symbol] =(∂ [symbol] p [symbol] /∂z)/(ω²*ρ₀). equation (4)

It follows that:

[symbol]

W [symbol] =ξ(1−R), equation (5)

where. ρ₀ is the density of air, and

ξ≡i/(ωZ₀), equation (5a)
with Z₀=ωρ₀/k₀ being the air impedance.

From the continuity of displacement, the reflection coefficient R is given by:

$$R = \frac{ξ - 〈 G 〉}{ξ + 〈 G 〉} . \qquad equation ( 6 )$$

Since A=1−|R|², the absorption coefficient A is given by:

$$A = \frac{4 ω {Z}_{0} Im 〈 G 〉}{{[ 1 + ω {Z}_{0} Im 〈 G 〉 ]}^{2} + {ω}^{2} {Z}_{0}^{2} Re {〈 G 〉}^{2}} . \qquad equation ( 7 )$$

According to equation (2), at the hybrid resonance ω=ωₙ and Re [symbol] G [symbol] =0, maximum absorption is found with Aₘₐₓ up to 1 when impedance of air is matched by that of the resonator, i.e., Z₀=Z=1/(ωIm [symbol] G [symbol] ). It should be noted that the absorption is low for the frequencies between two adjacent hybrid resonances.

Equation (2) has a typical Lorentzian form. For its real part, the sign changes below and above the resonant frequency ωₙ, and the magnitude decreases away from ωₙ. An incident wave with a frequency ω in-between two resonant modes will excite both modes but in opposite phases. At a particular frequency, the net surface-averaged component can vanish for a weakly dissipative system (which is usually the case for elastic membrane having a small viscous coefficient η). At this frequency, the composite resonator is mostly decoupled from external waves and behaves as a hard reflective surface which reflects sound energy instead of absorbs it. This frequency is denoted the anti-resonance frequency.

Dissipative medium, e.g., spongy material, can be placed in front of the resonator to absorb sound waves reflected from the anti-resonant surface. Any type of sponge that can interact with sound wave can be used, and many different types of spongy materials have been found to work. For low frequency sound absorption, the efficiency of a porous medium in front of a hard reflective wall is known to be low. Generally, the dissipation is from the relative motions between the solid medium and air, but if the displacement velocity of the wall has a node at the hard reflecting surface, then in the vicinity of the hard wall, the relative motion between the solid medium and air would be small, owing to the node at the hard wall, and hence small dissipation can be expected. This conclusion can only be altered if the dissipative solid medium is sufficiently thick, so that at distances sufficiently far away from the hard reflecting wall the standing sound wave can have sufficient wave amplitude. For the vibrational unit placed behind the dissipative medium, at anti-resonance where [symbol] W [symbol] ˜0, the resonator's surface still moves in the form of δW. The associated evanescent waves inside the dissipative medium can act as a frictional source. The surface of the decorated membrane effectively becomes “softer” because of the front dissipative layer, leading to the enhanced absorption of the reflected waves. The dissipative layer is configured to cover most or all of the active area of the membrane.

This “softening” effect near the anti-resonance can be demonstrated by considering the normal displacements of two hybrid resonances W₁^{(h)} and W₂^{(h)}. The surface-averaged Green function of the hybrid resonator can be written as:

$$〈 G 〉 ≃ {\sum }_{n = 1}^{2} \frac{{\vert 〈 {W}_{n}^{( h )} 〉 \vert}^{2}}{{ρ}_{n} ( {ω}_{n}^{2} - {ω}^{2} )} + 2 i β {\sum }_{n = 1}^{2} \frac{{\vert 〈 {W}_{n}^{( h )} 〉 \vert}^{2} ω}{{{ρ}_{n} ( {ω}_{n}^{2} - {ω}^{2} )}^{2}} , \qquad equation ( 8 )$$

where β is taken to be the averaged value of β₁ and β₂.

Here β represents the magnitude of the imaginary part of the Green function as defined by equation (8). The hybrid anti-resonance frequency \tilde{ω} is between ω₁ and ω₂.

The expansion can be written as:

$$\begin{matrix}〈 G 〉 ≃ 2 Ξ ( i β - Δ ω ) , & equation ( 9 ) \\ where Ξ ≡ {\sum }_{n = 1}^{2} \frac{{\vert 〈 {W}_{n}^{( h )} 〉 \vert}^{2} \tilde{ω}}{{{ρ}_{n} ( {ω}_{n}^{2} - {\tilde{ω}}^{2} )}^{2}} , and Δ ω ≡ \tilde{ω} - ω . & \end{matrix}$$

From the previous discussion, β increases due to the evanescent waves excited by the δW component inside the dissipative layer. Consequently, the surface averaged motion [symbol] W [symbol] = [symbol] G [symbol] p can become considerable at anti-resonance. That is, instead of a node at the planar vibrational unit's surface, there can be consideration wave amplitude at the vibrational unit's surface. Consequently the wave amplitude inside the dissipative medium can be considerable even at a short distance from the planar vibrational unit's surface.

Comparing the amplitude of the incident wave and that of the reflected wave at the membrane, R′ becomes:

$${R}^{′} ≃ \frac{1 - Im 〈 \overline{G} 〉}{1 + Im 〈 \overline{G} 〉} + i \frac{2 Re 〈 \overline{G} 〉}{{( 1 + Im 〈 \overline{G} 〉 )}^{2}} , \qquad equation ( 10 )$$

where G̅≡ωZ_{d}G with Z_{d} being the impedance of dissipative medium. It is also assumed that Re [symbol] G̅ [symbol] <<1 for frequencies in the vicinity of the anti-resonance. From equation (10), a transition of the reflection coefficient from 1 to −1 occurs when Im [symbol] G̅ [symbol] ∝β increases, corresponding to a change of from a node to an anti-node. Therefore, the sound absorption efficiency in the dissipative medium can be dramatically enhanced.

As a non-limiting example, in order for the evanescent modes to experience significant dissipation in the dissipative layer placed in front of the planar vibrational unit, the distance between the dissipative layer and the planar vibrational unit's surface should be less than 5 mm, with the best distance at less than 1 mm. This is due to the fact that the evanescent modes decay exponentially (in amplitude) away from the vibrational unit's surface. Hence at distances far away from the said surface the evanescent modes can not “feel” the dissipative layer's presence (is not responsive to the dissipation layer's presence), and hence dissipation becomes not possible.

The range of 5 mm to 1 mm separation between the dissipative layer and the front of the planar vibrational unit is given as a non-limiting example. It is also noted that the broadband absorption effect is still maintained if the dissipative layer physically touches the planar vibrational units (distance=0). The criterion for the minimum distance would be that the resonance modes can be still excited. Thus, the distance can be 0 for some types of dissipative materials, and conceivably, the dissipative material can engage the planar vibrational unit in an interference or compressive fit.

### Example

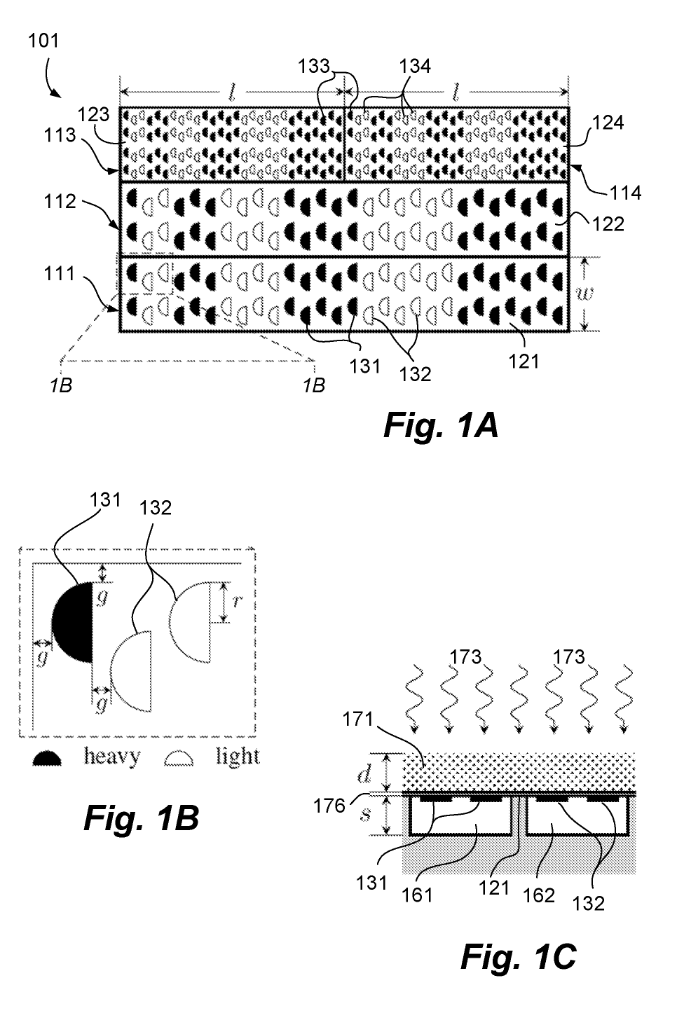

FIGS. 1A-C are schematic representations of a decorated membrane used in a sound suppression panel constructed in accordance with the present disclosure. FIG. 1A is a schematic representation of a top view of the decorated membrane. FIG. 1B is a detailed view of the decorated membrane of FIG. 1A, showing the area designated as 1B-1B in FIG. 1A, and showing a schematic representation of geometries of the rigid platelets decorated on the membrane. FIG. 1C is a schematic representation of a side view of a segment of the broadband acoustic absorption metamaterial of FIG. 1A.

Depicted is a panel 101, divided into sub-units, with four sub-units 111, 112, 113, 114 shown. Each sub-unit comprises a membrane 121, 122, 123, 124 onto which are mounted a plurality of platelets 131-134, providing a variation of resonant frequencies. Due to the fact that a foam or spongy layer will be used, platelets 131-134 are placed on the back sides of membranes 111-114, as will be described.

In the non-limiting example shown, membranes 121, 122 for the two larger sub-units 111, 112 are w×2l in size, with two rows of platelets 131, 132 attached. Membranes 123, 124 for the smaller sub-units 113, 114 are w×l, and four rows of platelets 133, 134 are attached. The sub-units 1 and 2 are smaller than the sub-units 3 and 4 so as to achieve higher resonant frequencies. Such frequency shifts are associated with the size of the sub-units because the larger units have smaller restoring forces, hence lower resonant frequencies. By way of non-limiting example, a possible dimension for the smaller panels 113, 114 are w×l is w=50 mm and l=150 mm. Following these dimensions, for the larger panels 111, 112, 2l=300 mm.

FIG. 1B specifies the geometric information of the platelets in this non-limiting example, in which g=4.55 mm and r=6 mm for platelets 131, 132 in the larger sub-units. For platelets 133 and 134 in the smaller sub-units g=2.275 mm and r=3 mm. In each row of platelets, the semicircular platelets 131-134 align in the same direction with two different area densities denoted by black (heavier, platelets 131, 133) and white (lighter, platelets 132, 134). Heavy platelets 131, 133 alternate with light platelets 132, 134 to form an arithmetic pattern. The purpose of such arrangement is to break both the mirror and translational symmetries of each rectangular membrane 121-124, thereby removing the degeneracy to realize more resonant modes within the targeted frequency range.

In a non-limiting example, the area densities of the heavy platelets are 6.44 kg/m² for sub-unit 111, 2.42 kg/m² for sub-unit 112, and 0.40 kg/m² for both sub-units 113 and 114. The light platelets have area densities of 3.54 kg/m² for sub-unit 111, 1.33 kg/m² for sub-unit 112, and 0.22 kg/m² for both smaller sub-units 113 and 114.

FIG. 1C shows a side view of the metamaterial, with sub-unit 111 given as an example. It is noted that the configuration for sub-units 112-114 also matches that of FIG. 1C. In this non-limiting example, membrane 121 seals air in an independent cuboid cell 161, 162, with a height of s=30 mm. Cuboid cells 161, 162 may house one or more platelets, such as platelets 131, 132. A layer 171 of foam or spongy material with a thickness of d=30 mm is placed on top of membrane 121 facing the incident sounds (arrows 173), with a separation 176 of 2 mm away from the surface of the vibrational unit (separating dimensions d and s in the drawing). The dimensions can be the same or different for each sub-unit 111-114 in the case of each of the cuboid cells 161, 162, gap 176 and foam or spongy layer 171. The platelets in each unit can have different masses.

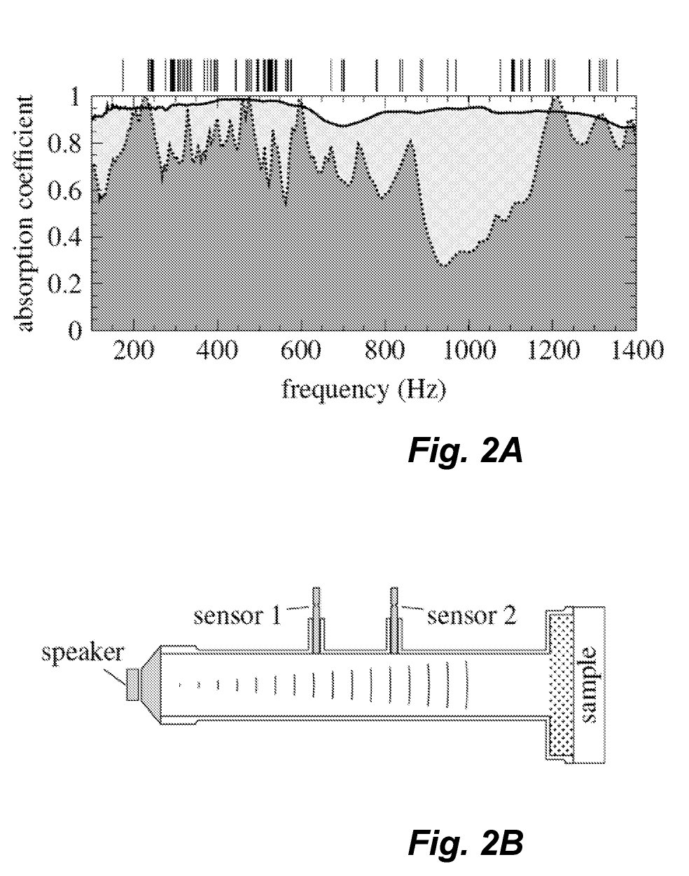

Numerical simulations show that, below 1400 Hz, this absorption metamaterial has 620 hybrid eigenmodes coupling to incoming waves. The hybrid eigenfrequencies of this membrane resonator are marked by thin vertical lines on the top of FIG. 2A. Since each eigenmode would have a small but finite frequency width, the aggregation of so many resonant eigenmodes leads to the absorption profile as shown by the dotted curve in FIG. 2A. Without the front dissipative layer, the membrane resonator shows a large number of absorption peaks (dotted curve in FIG. 2A) during experimental testing. After placing the front spongy layer at a distance of 2 mm from the vibrational unit's surface, absorption in the targeted frequency range is seen to be dramatically enhanced. This separation permits substantially free movement of the planar vibrational units with respect to the dissipative layer. Therefore, the eigenfrequencies are different from the absorption coefficients on the graph, which is an effect of the acoustically dissipative layer. From 100 Hz to 1400 Hz, all the absorption coefficients are higher than 85% (solid curve in FIG. 2A). It is further seen that the peaks of absorption are not lowered in the process.

Experimental Set-Up

FIGS. 2A and B are a depiction of absorption characteristics and a measurement setup used to generate the depiction. FIG. 2A is a graphic depiction of absorption characteristics of the broadband acoustic absorption metamaterial. FIG. 2B is a schematic representation of the measurement setup used to obtain the graphic depiction of FIG. 2A.

Measurements of the absorption coefficient were conducted in a Brüel & Kjær type-4206 impedance tube with the sample mounted on one end, as shown in FIG. 2B. Plane waves were generated by a loud speaker on the other end of the impedance tube. Two microphones were installed to sense the incident and reflected waves. The absorption coefficient was evaluated as A=1−R², with R being the measured reflection coefficient. The absorption measurements were calibrated to be accurate by using materials of known dissipations.

### CONCLUSION

It has been demonstrated that a high density of hybrid resonant modes in conjunction with acoustically dissipative layer stacked in front can be particularly effective for broadband absorption of sound energy in the low frequency regime. Since the structure is thin and lightweight, it can have broad applications. As particular non-limiting examples, the disclosed technology can be used for lowering the cabin noise in airliners and ships, tuning the acoustic quality of music halls, and environmental noise abatement along highways and railways.

It will be understood that many additional changes in the details, materials, steps and arrangement of parts, which have been herein described and illustrated to explain the nature of the subject matter, may be made by those skilled in the art within the principle and scope of the invention as expressed in the appended claims.

1. A sound suppression structure comprising:
a plurality of planar vibrational units establishing plural resonant frequencies;
a dissipative layer positioned on a front side of the planar vibrational units with the relative positioning of the dissipative layer and the planar vibrational units sufficient to permit movement of the planar vibrational units sufficient for excitation of the planar vibrational units at the resonance frequencies; and
a gas cell array interacting with the planar vibrational units to absorb energy at the resonant frequencies, the gas cell array comprising one or more of the planar vibration units forming one side of each gas cell in the gas cell array;
wherein the dissipative layer enhances absorption efficiency, resulting in absorption of energy at frequencies other than the resonant frequencies, the combination of the planar vibrational unit, the gas cells interacting with the planar vibrational unit and the dissipative layer providing a plurality of resonant modes for broadband sound absorption.

2. A sound suppression structure comprising:
a membrane;
resonant means mounted to or formed as part of the membrane, the resonant means comprising a plurality of planar vibrational units and establishing plural resonant frequencies;
sound dissipation means positioned on a front side of the resonant means and having means to permit substantially free movement of the planar vibrational units with respect to the sound dissipation means; and
backing means for the vibrational units and comprising means to interact with the resonant means to absorb energy at the resonant frequencies, the backing means comprising a gas cell array behind the planar vibrational units;
wherein the dissipative layer enhances absorption efficiency, resulting in absorption of energy at frequencies other than the resonant frequencies, the combination of the planar vibrational unit, the gas cells interacting with the planar vibrational unit and the dissipative layer providing a plurality of resonant modes for broadband sound absorption.

3. The sound suppression structure of claim 1, further comprising:
the plurality of planar vibrational units provided as rigid platelets mounted to a membrane layer.

4. The sound suppression structure of claim 1, further comprising:
the plurality of planar vibrational units arranged as rigid platelets mounted to a membrane layer with an inhomogeneous area density distribution.

5. The sound suppression structure of claim 1, further comprising:
at least a subset of the gas cells having a substantially sealed construction;

6. The sound suppression structure of claim 1, further comprising:
at least a subset of the gas cells having a vented construction, wherein the vented construction limits airflow sufficiently to allow the gas cells to respond to the energy at the resonant frequencies in the manner of sealed gas cells.

7. The sound suppression structure of claim 1, further comprising:
the gas cell array having a configuration to establish plural resonant frequencies can also be established by the gas cell array, with the plural resonant frequencies established by the gas cell array.

8. The sound suppression structure of claim 1, further comprising:
the gas cell array having a configuration to establish plural resonant frequencies can also be established by the gas cell array, with the plural resonant frequencies established by the gas cell array through the resonance of air inside each cell achieved by multiple, segmented gas cells, placed in an array.

9. The sound suppression structure of claim 1, further comprising:
the plurality of planar vibrational units provided as rigid platelets mounted to a membrane layer with an inhomogeneous area density distribution;
at least one subset of planar vibrational units configured to establish a different group of resonant frequencies from resonant frequencies established by at least one other subset of planar vibrational units, thereby exhibiting a high density of resonances that are clustered in frequency groups, spread over a wide frequency range, with said at least one subset and said other subset mounted on the same membrane layer and mounted to the membrane layer with a predetermined distribution between planar vibrational units of said one subset and said at least one other subset.

10. The sound suppression structure of claim 9, wherein the platelets in said one subset have the same shape but different area mass densities from the platelets in said at least one other subset.

11. The sound suppression structure of claim 1, further comprising:
the plurality of planar vibrational units arranged as rigid platelets mounted to a membrane layer with an inhomogeneous area density distribution, wherein:
a deformation component δW≡W− [symbol] W [symbol] that couples to evanescent waves in air,
where W denotes the displacement normal to the membrane and
< > represents surface averaging, for an acoustic wavelength λ much larger than lateral dimensions of the membrane,

|k_{∥}|>2π/λ for the k_{∥} components of δW,
where k_{∥} are Fourier wavevectors that delineate the lateral spatial displacement pattern W
and
the distribution of the k_{∥} components for [symbol] W [symbol] peaks at k_{∥}=0,
corresponding to coupling to radiative modes, the peaks corresponding to eigenstates.

12. The sound suppression structure of claim 1, further comprising:
the dissipative layer positioned on the front side of the planar vibrational units with a separation between the dissipative layer and the planar vibrational units sufficient to permit substantially free movement of the planar vibrational units with respect to the dissipative layer.

13. The sound suppression structure of claim 12, further comprising:
the dissipative layer having a separation from the surface of the planar vibrational unit less than 5 mm.

14. The sound suppression structure of claim 1, wherein the dissipative layer comprises spongy material.

15. The sound suppression structure of claim 1, further comprising:
the dissipative layer having a thickness of less than 50 mm.

16. The sound suppression structure of claim 1, further comprising:
the gas cells having varied thicknesses, with at least a subset of the gas cells having a thickness of less than 30 cm.

17. The sound suppression structure of claim 1, further comprising:
the plurality of planar vibrational units having different area mass densities.

18. The sound suppression structure of claim 1, further comprising:
the plurality of planar vibrational units having asymmetric shapes.

19. The sound suppression structure of claim 1, further comprising:
the plurality of planar vibrational units positioned on the membrane without translational symmetry.

20. The sound suppression structure of claim 1, further comprising:
the plurality of planar vibrational units provided as rigid platelets mounted to a membrane layer; and
the membrane layer having a tension that ranges from 1×10² to 1×10⁸ Pa.

21. The sound suppression structure of claim 1, further comprising:
the plurality of planar vibrational units provided as rigid platelets mounted to a membrane layer; and
the membrane layer having a tension that ranges from 3.45×10⁵ to 3.5×10⁵ Pa.

22. The sound suppression structure of claim 1, further comprising:
a hard, porous cover with a period array of holes so as to allow the incident sound to pass through.

23. The sound suppression structure of claim wherein the structure displays an acoustic wave absorption coefficient of more than 4 dB from 250 Hz to 5000 Hz, an acoustic wave absorption coefficient of more than 7 dB from 1500 to 5000 Hz, and an acoustic wave absorption coefficient of more than 10 dB from 1900 Hz to 5000 Hz.

24. A method for sound suppression, comprising:
providing a membrane with a plurality of planar vibrational units mounted thereon and using the planar vibrational units to establish plural resonant frequencies;
providing a dissipative layer positioned on a front side of the planar vibrational units, with the dissipative layer and the planar vibrational units sufficient to permit movement of the planar vibrational units sufficient for excitation of the planar vibrational units at the resonance frequencies; and
positioning a gas cell array behind the planar vibrational units to interact with the planar vibrational unit to absorb energy at the resonant frequencies;
wherein the dissipative layer enhances absorption efficiency, resulting in absorption of energy at frequencies other than the resonant frequencies, the combination of the planar vibrational unit, the gas cell interacting with the planar vibrational unit and the dissipative layer providing a plurality of resonant modes for broadband sound absorption.

25. The method of claim 24, further comprising:
providing the plurality of planar vibrational units as rigid platelets and mounting the platelets to a membrane layer.

26. The method of claim 24, further comprising:
arranging the plurality of planar vibrational units as rigid platelets by mounting the platelets to a membrane layer with an inhomogeneous area density distribution.

27. The method of claim 24, further comprising:
using a gas cell array having at least a subset of the gas cells having a substantially sealed construction;

28. The method of claim 24, further comprising:
using a gas cell array having at least a subset of the gas cells having a vented construction, wherein the vented construction limits airflow sufficiently to allow the gas cells to respond to the energy at the resonant frequencies in the manner of sealed gas cells.

29. The method of claim 24, further comprising:
using a gas cell array having a configuration to establish plural resonant frequencies can also be established by the gas cell array, with the plural resonant frequencies established by the gas cell array.

30. The method of claim 24, further comprising:
using a gas cell array having a configuration to establish plural resonant frequencies can also be established by the gas cell array, with the plural resonant frequencies established by the gas cell array through the resonance of air inside each cell achieved by multiple, segmented gas cells, placed in an array.

31. The method of claim 24, further comprising:
providing the plurality of planar vibrational units as rigid platelets mounted to a membrane layer with an inhomogeneous area density distribution;
configuring at least one subset of planar vibrational units to establish a different group of resonant frequencies from resonant frequencies established by at least one other subset of planar vibrational units, thereby exhibiting a high density of resonances that are clustered in frequency groups, spread over a wide frequency range, with said at least one subset and said other subset mounted on the same membrane layer and mounted to the membrane layer with a predetermined distribution between planar vibrational units of said one subset and said at least one other subset.

32. The method of claim 31, wherein the platelets in said one subset have the same shape but different area mass densities from the platelets in said at least one other subset.

33. The method of claim 24, further comprising:
arranging the plurality of planar vibrational units as rigid platelets mounted to a membrane layer with an inhomogeneous area density distribution, wherein:
a deformation component δW≡W− [symbol] W [symbol] that couples to evanescent waves in air,
where W denotes the displacement normal to the membrane and [symbol] [symbol] represents surface averaging, for an acoustic wavelength λ much larger than lateral dimensions of the membrane,

|k_{∥}|>2π/λ for the k_{∥} components of δW,
where k_{∥} are Fourier wavevectors that delineate the lateral spatial displacement pattern W
and
the distribution of the k_{∥} components for [symbol] W [symbol] peaks at k_{∥}=0,
corresponding to coupling to radiative modes, the peaks corresponding to eigenstates.

34. The method of claim 24, further comprising:
positioning the dissipative layer on the front side of the planar vibrational units with a separation between the dissipative layer and the planar vibrational units sufficient to permit substantially free movement of the planar vibrational units with respect to the dissipative layer.

35. The method of claim 34, further comprising:
providing the dissipative layer with a thickness of less than 50 mm.

36. The method of claim 24, wherein the dissipative layer comprises spongy material.

37. The method of claim 23, further comprising:
providing a separation of the dissipative layer from the surface of the planar vibrational unit by less than 5 mm.

38. The method of claim 24, further comprising:
the gas cells having varied thicknesses, with at least a subset of the gas cells having a thickness of less than 30 cm.

39. The method of claim 24, further comprising:
the plurality of planar vibrational units having different area mass densities.

40. The method of claim 24, further comprising:
the plurality of planar vibrational units having asymmetric shapes.

41. The method of claim 24, further comprising:
positioning the plurality of planar vibrational units on the membrane without translational symmetry.

42. The method of claim 24, further comprising:
the plurality of planar vibrational units provided as rigid platelets mounted to a membrane layer; and
the membrane layer having a tension that ranges from 1×10² to 1×10⁸ Pa.

43. The method of claim 24, further comprising:
providing the plurality of planar vibrational units as rigid platelets mounted to a membrane layer; and
the membrane layer having a tension that ranges from 3.45×10⁵ to 3.5×10⁵ Pa.

44. The method of claim 24, further comprising:
providing a hard, porous cover with a period array of holes so as to allow the incident sound to pass through.

45. The method of claim 24, wherein the structure displays an acoustic wave absorption coefficient of more than 4 dB from 250 Hz to 5000 Hz, an acoustic wave absorption coefficient of more than 7 dB from 1500 to 5000 Hz, and an acoustic wave absorption coefficient of more than 10 dB from 1900 Hz to 5000 Hz.
